(19) United States
(12) Patent Application Publication
(10) Pub. No.: US 2025/0347424 A1
(43) Pub. Date: Nov. 13, 2025

(54) SPLIT-TYPE RANGE HOOD SYSTEM WITH WIRELESS SERIES CONNECTION FUNCTION

(71) Applicant: BLUESKY COOKING STYLE CO., LTD., Taipei City (TW)

(72) Inventor: CHIN-JUNG LIAO, Taipei City (TW)

(21) Appl. No.: 19/055,456

(22) Filed: Feb. 17, 2025

(30) Foreign Application Priority Data
May 9, 2024 (TW) 113117090

(51) Int. Cl. F24C 15/20

(52) U.S. Cl. CPC F24C 15/2021; F24C 15/2042

(57) ABSTRACT

A split-type range hood system with a wireless series connection function includes a range hood main body, a near-end relay fan, a plurality of repeaters and a far-end relay fan. The range hood main body, the near-end relay fan and the far-end relay fan are communicated with each other, and the range hood main body, the near-end relay fan, the multiple repeaters and the far-end relay fan cooperate with each other to form a wireless series connection system using a wireless mesh network technology, so that when the range hood main body is turned on, the range hood main body is configured to transmit an activation signal to the near-end relay fan and the far-end relay fan through the wireless mesh network technology to synchronously turn on the near-end relay fan and the far-end relay fan.

### CROSS-REFERENCE TO RELATED PATENT APPLICATION

This application claims the benefit of priority to Taiwan Patent Application No. 113117090, filed on May 9, 2024. The entire content of the above identified application is incorporated herein by reference.

Some references, which may include patents, patent applications and various publications, may be cited and discussed in the description of this disclosure. The citation and/or discussion of such references is provided merely to clarify the description of the present disclosure and is not an admission that any such reference is “prior art” to the disclosure described herein. All references cited and discussed in this specification are incorporated herein by reference in their entireties and to the same extent as if each reference was individually incorporated by reference.

### FIELD OF THE DISCLOSURE

The present disclosure relates to a range hood, and more particularly to a split-type range hood system with a wireless series connection function.

### BACKGROUND OF THE DISCLOSURE

In the related art, the split-type range hood includes a range hood main body and a motor (or a relay motor or a relay fan) separated from each other according to a separate design, so that the relay fan can be installed outside the kitchen to reduce the disturbing noise generated by the motor during cooking.

The range hood main body and the relay fan need to be communicated with each other through an exhaust pipe to discharge the oil smoke to the outdoor environment. However, as island kitchens or open kitchens become more and more popular, the kitchen is getting closer and closer to the center of the home, making the length of the exhaust pipe to the balcony or outdoors longer and longer, thus affecting the smoke exhaust efficiency. For this reason, not only one relay fan is needed, but even two or three or more relay fans are needed, and they are wirelessly connected to the range hood main body through repeaters. However, during the wireless transmission process of the start signal transmitted from the range hood main body in a wireless manner, one of the repeaters will often be disconnected or damaged, causing subsequent network connections to be interrupted, making it impossible to ensure that the remote relay fans can be turned on simultaneously, which will cause a long-term problem that has troubled industry operators and users.

### SUMMARY OF THE DISCLOSURE

In response to the above-referenced technical inadequacy, the present disclosure provides a split-type range hood system with a wireless series connection function.

In order to solve the above-mentioned problems, one of the technical aspects adopted by the present disclosure is to provide a split-type range hood system with a wireless series connection function, which includes a range hood main body, a near-end relay fan, a plurality of repeaters and a far-end relay fan. The range hood main body, the near-end relay fan and the far-end relay fan are communicated with each other, and the range hood main body, the near-end relay fan, the plurality of repeaters and the far-end relay fan cooperate with each other to form a wireless series connection system using a wireless mesh network technology, so that when the range hood main body is turned on, the range hood main body is configured to transmit an activation signal to the near-end relay fan and the far-end relay fan through the wireless mesh network technology to synchronously turn on the near-end relay fan and the far-end relay fan.

In one of the possible or preferred embodiments, the far-end relay fan is a common remote relay fan installed on a top portion of a building, and the range hood main body and the near-end relay fan are communicated with the far-end relay fan through a common exhaust duct.

In one of the possible or preferred embodiments, the far-end relay fan is communicated with at least another range hood main body through the common exhaust duct, and the far-end relay fan is configured to receive another activation signal transmitted from the at least another range hood main body through the wireless mesh network technology. When the far-end relay fan is configured to operate at a first rotation speed and receive the another activation signal transmitted from the at least another range hood main body through the wireless mesh network technology, the far-end relay fan is operated from the first rotation speed to a second rotation speed.

In one of the possible or preferred embodiments, the far-end relay fan includes a plurality of remote sub-fans that are connected in parallel.

In one of the possible or preferred embodiments, the far-end relay fan is communicated with at least another range hood main body through the common exhaust duct, and the far-end relay fan is configured to receive another activation signal transmitted from the at least another range hood main body through the wireless mesh network technology. When one of the plurality of remote sub-fans of the far-end relay fan is configured to operate and receive the another activation signal transmitted from the at least another range hood main body through the wireless mesh network technology, another one of the plurality of remote sub-fans of the far-end relay fan is operated synchronously.

These and other aspects of the present disclosure will become apparent from the following description of the embodiment taken in conjunction with the following drawings and their captions, although variations and modifications therein may be affected without departing from the spirit and scope of the novel concepts of the disclosure.

### BRIEF DESCRIPTION OF THE DRAWINGS

The described embodiments may be better understood by reference to the following description and the accompanying drawings, in which:

FIG. 1 is a schematic view of a split-type range hood system according to an embodiment of the present disclosure;

FIG. 2 is a schematic view of the split-type range hood system according to another embodiment of the present disclosure; and

FIG. 3 is a functional block diagram of a far-end relay fan of the split-type range hood system according to another embodiment of the present disclosure.

### DETAILED DESCRIPTION OF THE EXEMPLARY EMBODIMENTS

The present disclosure is more particularly described in the following embodiments and examples that are intended as illustrative only since numerous modifications and variations therein will be apparent to those skilled in the art. Like numbers in the drawings indicate like components throughout the views. As used in the description herein and throughout the claims that follow, unless the context clearly dictates otherwise, the meaning of “a,” “an” and “the” includes plural reference, and the meaning of “in” includes “in” and “on.” Titles or subtitles can be used herein for the convenience of a reader, which shall have no influence on the scope of the present disclosure.

The terms used herein generally have their ordinary meanings in the art. In the case of conflict, the present document, including any definitions given herein, will prevail. The same thing can be expressed in more than one way. Alternative language and synonyms can be used for any term(s) discussed herein, and no special significance is to be placed upon whether a term is elaborated or discussed herein. A recital of one or more synonyms does not exclude the use of other synonyms. The use of examples anywhere in this specification including examples of any terms is illustrative only, and in no way limits the scope and meaning of the present disclosure or of any exemplified term. Likewise, the present disclosure is not limited to various embodiments given herein. Numbering terms such as “first,” “second” or “third” can be used to describe various components, signals or the like, which are for distinguishing one component/signal from another one only, and are not intended to, nor should be construed to impose any substantive limitations on the components, signals or the like.

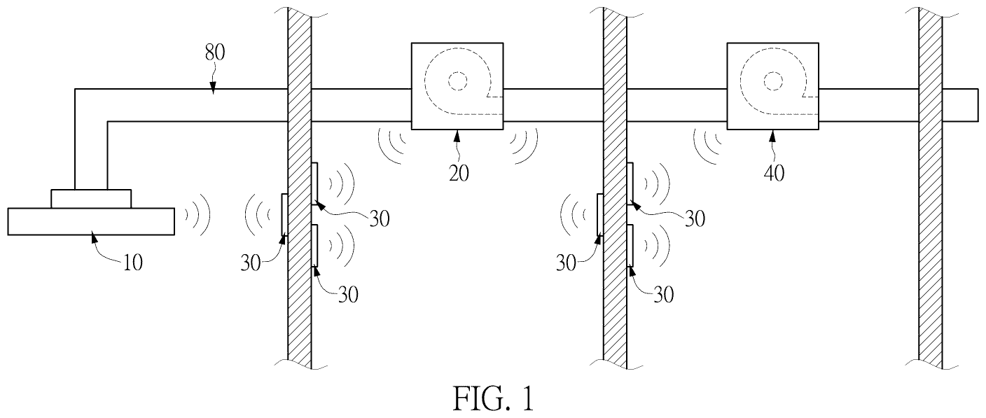

Referring to FIG. 1, the present disclosure provides a split-type range hood system with a wireless series connection function, which basically includes a range hood main body 10, a near-end relay fan 20 (or a proximal relay fan such as a blower fan), a plurality of repeaters 30, and a far-end relay fan 40 (or a remote relay fan such as a blower fan).

In this embodiment, the range hood main body 10, the near-end relay fan 20 and the far-end relay fan 40 are configured to be communicated with each other. That is to say, the range hood main body 10, the near-end relay fan 20 and the far-end relay fan 40 can be in air communication with other through an exhaust duct 80.

Furthermore, in this embodiment, the range hood main body 10, the near-end relay fan 20, the plurality of repeaters 30, and the far-end relay fan 40 cooperate with each other to form a wireless series connection system using a wireless mesh network technology, so that when the range hood main body 10 is turned on, an activation signal (or an enabling signal) can be transmitted to the near-end relay fan 20 and the far-end relay fan 40 through the wireless mesh network technology to simultaneously or synchronously turn on (or activate) the near-end relay fan 20 and the far-end relay fan 40. In this way, during the activation signal transmission process, even if one repeater 30 is disconnected or damaged, the activation signal can automatically jump and bridge (connect in series) to an available repeater 30, so that it will not happen that one repeater 30 is disconnected or damaged, and the subsequent network connections are interrupted. Even if the activation signal is unstable or even lost due to the obstruction of the steel structure of the house and layers of walls and floors, the subsequent network transmission will not be interrupted, so that the activation signal can be transmitted to the far-end relay fan 40 normally and stably, thereby ensuring that the far-end relay fan 40 can be turned on synchronously.

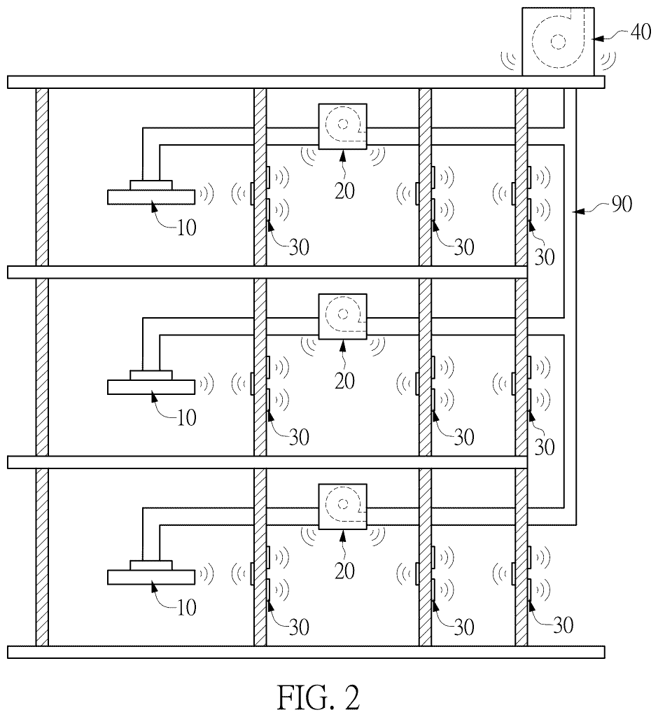

In one embodiment, referring to FIG. 2, the far-end relay fan 40 is a common remote relay fan installed on the top of a building. Moreover, the range hood main body 10 and the near-end relay fan 20 are communicated with the far-end relay fan 40 through a common exhaust duct 90. It should be noted that other range hood main bodies 10 and the other near-end relay fans 20 can also be communicated with the far-end relay fan 40 through the common exhaust duct 90.

Furthermore, the far-end relay fan 40 can receive the activation signal transmitted from at least another one of the range hood main bodies 10 through the wireless mesh network technology. Moreover, when the far-end relay fan 40 is operating at a first rotation speed and receives an activation signal transmitted from at least another one of the range hood main bodies 10 through the wireless mesh network technology, the far-end relay fan 40 can be operated from the first rotation speed to a second rotation speed (that is to say, the speed of the far-end relay fan 40 is increased to a higher speed than the current speed), so that a large amount of oil smoke accumulated in the common exhaust duct 90 can be quickly discharged from the top of the building through the far-end relay fan 40 operating at a higher speed (i.e., the second rotation speed).

In detail, when the far-end relay fan 40 receives an activation signal from one of the range hood main bodies 10 through the wireless mesh network technology, the far-end relay fan 40 can be operated at a first rotation speed. When the far-end relay fan 40 is operating at the first rotation speed and receives another activation signal from another one of the range hood main bodies 10 through the wireless mesh network technology, the operation of the far-end relay fan 40 can be increased from the first rotation speed to a second rotation speed. When the far-end relay fan 40 is operating at the second rotation speed and receives yet another activation signal from yet another one of the range hood main bodies 10 through the wireless mesh network technology, the operation of the far-end relay fan 40 can be increased from the second rotation speed to a third speed (i.e., increasing to the maximum rotation speed for operation). Moreover, since the far-end relay fan 40 of this embodiment is a common remote relay fan installed on the top of the building, the maximum rotation speed of the far-end relay fan 40 is greater than the maximum rotation speed of the near-end relay fan 20, which can effectively improve the smoke exhaust efficiency without causing disturbing noise that affects indoor cooking.

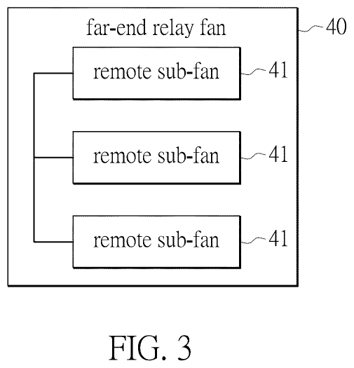

In one embodiment, referring to FIG. 2 and FIG. 3, the far-end relay fan 40 includes a plurality of remote sub-fans 41 connected in parallel (that is to say, the plurality of remote sub-fans 41 can be connected in parallel to form the far-end relay fan 40). Moreover, when one of the remote sub-fans 41 of the far-end relay fan 40 is operating and receives an activation signal transmitted from at least another one of the range hood main bodies 10 through the wireless mesh network technology, at least another one of the remote sub-fans 41 of the far-end relay fan 40 can operate synchronously (that is to say, at least two remote sub-fans 41 can be operated synchronously), so that a large amount of oil smoke accumulated in the common exhaust duct 90 can be quickly discharged from the top of the building through at least two remote sub-fans 41 of the far-end relay fan 40 that can be operated synchronously.

In detail, when the far-end relay fan 40 receives an activation signal from the range hood main body 10 through the wireless mesh network technology, one of the remote sub-fans 41 that are connected in parallel in the far-end relay fan 40 can be operated. When one of the remote sub-fans 41 of the far-end relay fan 40 is operating and receives an activation signal transmitted from another one of the range hood main bodies 10 through the wireless mesh network technology, two of the remote sub-fans 41 that are connected in parallel in the far-end relay fan 40 can be operated synchronously. When two of the remote sub-fans 41 of the far-end relay fan 40 are operating and receive an activation signal transmitted from yet another one of the range hood main bodies 10 through the wireless mesh network technology, the three remote sub-fans 41 that are connected in parallel in the far-end relay fan 40 can be operated synchronously (that is to say, all remote sub-fans 41 connected or communicated in parallel in the far-end relay fan 40 can be operated synchronously).

Based on the above, the split-type range hood system with a wireless series connection function provided by the present disclosure includes a range hood main body 10, a near-end relay fan 20, a plurality of repeaters 30, and a far-end relay fan 40. The range hood main body 10, the near-end relay fan 20 and the far-end relay fan 40 are communicated with each other, and the range hood main body 10, the near-end relay fan 20, the plurality of repeaters 30, and the far-end relay fan 40 can cooperate with each other to form a wireless series connection system using a wireless mesh network technology, so that when the range hood main body 10 is turned on, the activation signal provided by the range hood main body 10 can be transmitted to the near-end relay fan 20 and the far-end relay fan 40 through the wireless mesh network technology to simultaneously or synchronously turn on the near-end relay fan 20 and the far-end relay fan 40. In this way, during the activation signal transmission process, even if one repeater 30 is disconnected or damaged, the activation signal can automatically jump and bridge (connect in series) to an available repeater 30, so that it will not happen that one repeater 30 is disconnected or damaged, and the subsequent network connections are interrupted. Even if the activation signal is unstable or even lost due to the obstruction of the steel structure of the house and layers of walls and floors, the subsequent network transmission will not be interrupted, so that the activation signal can be transmitted to the far-end relay fan 40 normally and stably, thereby ensuring that the far-end relay fan 40 can be turned on synchronously.

The foregoing description of the exemplary embodiments of the disclosure has been presented only for the purposes of illustration and description and is not intended to be exhaustive or to limit the disclosure to the precise forms disclosed. Many modifications and variations are possible in light of the above teaching.

The embodiments were chosen and described in order to explain the principles of the disclosure and their practical application so as to enable others skilled in the art to utilize the disclosure and various embodiments and with various modifications as are suited to the particular use contemplated. Alternative embodiments will become apparent to those skilled in the art to which the present disclosure pertains without departing from its spirit and scope.

What is claimed is:

1. A split-type range hood system with a wireless series connection function, comprising: a range hood main body, a near-end relay fan, a plurality of repeaters and a far-end relay fan, wherein the range hood main body, the near-end relay fan and the far-end relay fan are communicated with each other, and the range hood main body, the near-end relay fan, the plurality of repeaters and the far-end relay fan cooperate with each other to form a wireless series connection system using a wireless mesh network technology, so that when the range hood main body is turned on, the range hood main body is configured to transmit an activation signal to the near-end relay fan and the far-end relay fan through the wireless mesh network technology to synchronously turn on the near-end relay fan and the far-end relay fan.

2. The split-type range hood system according to claim 1, wherein the far-end relay fan is a common remote relay fan installed on a top portion of a building, and the range hood main body and the near-end relay fan are communicated with the far-end relay fan through a common exhaust duct.

3. The split-type range hood system according to claim 2, wherein the far-end relay fan is communicated with at least another range hood main body through the common exhaust duct, and the far-end relay fan is configured to receive another activation signal transmitted from the at least another range hood main body through the wireless mesh network technology; and wherein, when the far-end relay fan is configured to operate at a first rotation speed and receive the another activation signal transmitted from the at least another range hood main body through the wireless mesh network technology, the far-end relay fan is operated from the first rotation speed to a second rotation speed.

4. The split-type range hood system according to claim 2, wherein the far-end relay fan includes a plurality of remote sub-fans that are connected in parallel.

5. The split-type range hood system according to claim 4, wherein the far-end relay fan is communicated with at least another range hood main body through the common exhaust duct, and the far-end relay fan is configured to receive another activation signal transmitted from the at least another range hood main body through the wireless mesh network technology; and wherein, when one of the plurality of remote sub-fans of the far-end relay fan is configured to operate and receive the another activation signal transmitted from the at least another range hood main body through the wireless mesh network technology, another one of the plurality of remote sub-fans of the far-end relay fan is operated synchronously.
